(19) United States
(12) Patent Application Publication
(10) Pub. No.: US 2008/0237258 A1
(43) Pub. Date: Oct. 2, 2008

(54) Fluid Dispenser and Fluid Dispensing Assembly

(76) Inventor: Alan Joseph Green, Glasgow (GB)

Correspondence Address: BROOKS KUSHMAN P.C., 1000 TOWN CENTER, TWENTY-SECOND FLOOR, SOUTHFIELD, MI, 48075, US

(21) Appl. No.: 12/065,141

(22) PCT Filed: Aug. 25, 2006
(86) PCT No.: PCT/GB06/03188

§ 371 Date: Feb. 28, 2008

(30) Foreign Application Priority Data
Aug. 30, 2005 (GB) 0517722.5
Mar. 16, 2006 (GB) 0605311.0
May 5, 2006 (GB) 0608872.8

(51) Int. Cl. B67D 5/00; B65D 35/22

(52) U.S. Cl. 222/81; 222/94; 222/129

(57) ABSTRACT

The invention herein described relates to fluid filled blister packs (1) and provides an alternative to dosing bottles and packs. An apparatus is disclosed for dispensing liquids, creams or gels in dosed amounts from blisters (1), and an assembly (4) in which the apparatus is located on an array of blisters. The apparatus has particular application for the dispensing of alcohol gels used in the healthcare industry.

The present invention relates to an apparatus and an associated assembly for dispensing fluids, in particular for dispensing fluid from fluid filled blisters and blister packs.

This invention has particular relevance as an alternative to bottles for shower soaps, dispensers for skin creams and small body worn packs for dispensing liquid, cream or gels, especially healthcare alcohol gels.

Bottles of various types have historically been used to dispense fluids. The larger bottles may be more cost effective to refill than smaller bottles but refilling can present a spillage hazard and it is time consuming. Some bottles for liquid fluids are valved and have pump dispensers. These pumps are liable to clogging especially if re-used after refilling, and the smaller bottles are not cost effective to refill. Also, the smaller the bottle the more expensive it is in comparison to the fluid it contains. The aforesaid bottle products, when successful, are used in vast quantities and even small innovations leading to production cost improvement or environmental impact would be considered very desirable.

In the health care industry there are now many companies that have their own proprietary design of body worn carry bottle for alcohol gel and specialised hanging shower gel bottles. Hanging bottles generally don't have a dosed fluid release.

Valved dosing bottles are more than twice as expensive as non dosing bottles due to the cost of the valved dosing mechanism. Furthermore, jars of skin cream may be unhygienic, and valves used with creams will block.

In relation to dispensing alcohol gels in a clinical setting, these bottles may go to landfill and they present a challenge to obtain a minimum volume and to reduce costs with respect to environmental impact.

In general, users in the healthcare field prefer dosing bottles. In addition, some food containers are better dosed. From a consumer point of view, tubes can be untidy.

Blister packs, especially sachet packs also are and have been used to carry and dispense small quantities of fluids, creams and pastes. Inexpensive deadfold material for blister construction has been known for many years.

Blisters are well known to prevent contamination and drying out of their contents but have not been developed to offer a multiple dosing replacement for paste filled tubes.

Blister encapsulation can address the disadvantages associated with bottles but there does not appear in prior art a practical mechanism for directly replacing the use of small bottles (either valved or unvalved) with a plurality of compressible blisters, combined to form a single product that provides a multi dosing dispensing reservoir for a fluid agent.

In addition, a blister pack that may stand up or hang could offer a tidy alternative to, for example, a half empty tube lying on a surface.

Fluid filled blister packs have been known for many years and liquid fluid filled blister packs both of the sachet and formed cavity type have been well documented. This field of innovation is very active with many companies and individuals continually innovating new materials and products in the healthcare and cosmetic packaging industries.

Single dispensing, seam bursting blisters are known, for example the ‘Dell Pouch’.

One of the most common type of liquid filled blisters is the heat sealed condiment sachet that is torn open; other fluid filled blisters are known ranging from powder filled asthma reservoirs that are pierced to open and press to open liquid applicators that are squeezed, to burst open a frangible seal. There are also blisters with peel seals and crack open seals and tear open single alcohol gel filled blisters.

Prior art does have at least one case of a liquid fluid product having multiple blisters, namely Harper (WO2004/062696). However, Harper does not have drawings that are accessible nor is there a full description of how to practically achieve a working product in the available disclosure nor is the concept described intended for use in the same manner as a bottle.

Individual sachets in a pocket do not have the convenience and ergonomic advantages of a unitary multi dosing product.

Single blisters, usually of the sachet type, generally require two hands to tear open and as the contents may require to be deposited on a hand this is not optimally ergonomic. If a press open means is used, such blisters may be liable to accidental opening and if left joined together as a single product they would possibly not have the handling ergonomics of a small bottle. Furthermore, a tear open means would probably be rather untidy and problematic regarding flow control.

Further relevant prior art is available, such as Hafner WO02/083057, Mille FR2747647, Harper (above) and Glaxo GB2142246A, none of which teach sufficiently to replace the function and use of a simple carry bottle for dispensing fluids. Harper tried to address these issues following his application already described and proposed a valved blister for a pocket in US2005035006.

A further consideration is the substantial difference in the concept of formed blisters and sachet type blisters. Thermoformed blisters, even flexible ones, grouped together may have an inherent overall unity of structure that is readily conceived and in fact exists already, for example in pill packs. Sachets are far more uncontrollably flexible.

Since EP94304227 (Lilly, 1994), notwithstanding the direction of this art, many working in the field of liquid filled blisters and personal carried fluids have not arrived at the devices herein revealed.

Liquid filled blister packs with a plurality of blisters have been proposed, see Harper & Glaxo patents, but no mechanism for achieving a product has been taught to include a dispensing means that co-operates dimensionally with or is fitted to or supported by a fluid containing blister pack with a plurality of blisters.

Sachet blisters are conceived as very flexible, especially at joined areas, and to provide a grouping of sachet blisters with an overall unity and firmness for use as one product in a multi dispensing mode is not taught by the prior art. Such a grouping of sachets may be made uniquely ergonomic for the user as a foldable and flexible product. It is well known in the art that sachets are cheaper to produce than thermoformed blisters and that they empty of fluid more completely.

It is therefore an object of the present invention to provide an apparatus for dispensing fluid from fluid filled blisters and blister packs.

It is a further object of the present invention to provide an assembly comprising fluid filled blisters or blister packs and capable of dispensing fluid therefrom.

According to a first aspect of the present invention, there is provided a dispensing apparatus for dispensing fluid from a blister containing a fluid, the dispensing apparatus comprising:
an opening means and a carrying means;
the opening means comprising a first member adapted to compress the blister in cooperation with an opposing member; and
the carrying means adapted to moveably locate the opening means relative to the blister.

The opposing member may be the finger of a user, the surface of an arm upon which the blister is located, or another surface of the dispensing apparatus or of an associated assembly. The blister may be a single, standalone blister or sachet, or alternatively one of an array of blisters or sachets which the dispensing apparatus may be located upon or around and moved along.

Preferably, the carrying means is adapted to relatively move the opening means at least partially transversely across a surface of the blister.

Preferably, the opening means further comprises a second member opposing the first member, adapted to cooperate with the first member.

Preferably, the carrying means comprises a channel defined by the first and second members which receives and at least partially encloses the blister.

Preferably, the first and second members are relatively moveable so as to be urged into contact with the blister and pressurise the fluid.

Preferably, the first member and second member are shaped so as to substantially engage one another when urged toward contact.

Preferably, the dispensing apparatus provides a preferred fluid flow path for expression of the fluid from the blister.

Preferably, the dispensing apparatus further comprises an aperture configured so as to define the preferred fluid flow path.

Preferably, the opening means comprises a piercing means operable to provide an opening in the blister.

Preferably, the opening means is adapted to simultaneously pressurise the fluid and provide an opening in the blister.

Preferably, the piercing means is located on an inner surface of the dispensing means.

Preferably, the piercing means is located so as to provide an opening proximal to a boundary of the blister.

Preferably, the piercing means is located proximal to the aperture.

Preferably, the piercing means is shaped to create an opening capable of cooperating with the preferred fluid flow path.

Optionally, the piercing means is shaped so as to create a linear opening in the blister.

Alternatively, the piercing means is shaped so as to create a substantially arcuate opening in the blister.

Preferably, the dispensing means further comprises a relief structure located on an inner surface opposing the piercing means and adapted to cooperate with the piercing means.

Optionally, the relief structure comprises a hardened portion adapted to receive the piercing means.

Optionally, the opening means further comprises a gasket portion adapted to provide a partial seal proximal to the opening and to cooperate with the preferred fluid flow path such that the fluid is directed from the opening to the aperture.

Alternatively, the opening means is operable to burst the blister.

Preferably, the opening means is adapted so as to burst the blister proximal to the aperture.

Optionally, the second member is a substantially cylindrical member adapted to receive a finger.

Alternatively, the first member comprises an elongate portion moveable so as to be urged into contact with the blister.

Preferably, the first member is operable to provide an opening in the blister.

Preferably, the first member is moveable between a first protected location and a second location on or near the blister.

According to a second aspect of the present invention, there is provided an assembly comprising:
an array comprising one or more blisters and a dispensing apparatus in accordance with the first aspect;
wherein the carrying means of the dispensing apparatus movably locates the opening means relative to the one or more blisters.

Preferably, the dispensing apparatus is movably locatable on each of the one or more blisters.

Preferably, the assembly further comprises a locating means adapted to locate the dispensing apparatus on or near one of the blisters.

Preferably, the locating means is adapted to preferentially locate the opening means on or near one of the blisters.

Preferably, the locating means is adapted to allow movement of the opening means such that it is moveable between a location on or near one of the blisters to a location on or near another of the blisters.

Optionally, the locating means comprises one or more indicia on the array.

Alternatively, the locating means comprises a guiding means supporting the dispensing apparatus and adapted to guide the dispensing apparatus along the array.

Yet further alternatively, the locating means comprises a relief structure on the array which cooperated with the dispensing apparatus.

Preferably, the relief structure is formed by raised surfaces of the one or more blisters.

Preferably, the array comprises shaping means adapted to form the array into a predetermined shape.

Preferably, the shaping means is further adapted to allow the array to move between a plurality of predetermined shapes.

Optionally, the shaping means is a rigid member adapted to fixedly retain the array in a predetermined shape.

Preferably, the shaping means comprises a stiffening portion disposed along one or more edges of the array.

Preferably, the shaping means is deformable.

Optionally, the shaping means comprises one or more hinged portions.

Optionally, the shaping means is adapted to shape the array into a loop.

Preferably, fixing means are provided at either end of the array so as to fixedly retain the array as a loop.

Alternatively, the array is adapted to receive a coiling means which shapes the array into a coil.

Alternatively, the shaping means is adapted to shape the array so as to locate the assembly on a limb of a user.

Optionally, the one or more blisters comprise frangible seals.

Alternatively, the one or more blisters comprise burstable seals.

Preferably, the one or more blisters are sachets.

Alternatively, the one or more blisters are stick packs.

According to a third aspect of the present invention, there is provided a dispensing means for dispensing fluid from a fluid filled blister or blister pack reservoir comprising a reservoir opening means and a carrying means for the opening means, the opening means is characterised as having compression means which, in use, facilitates a squeezing compression of the blister, such means being able to be depressed towards the blister surface and being relatively moveable across the blister or blister pack surface, the compression means being characterised as comprising an inside surface that is able to co-operate with an opposing surface, between which a blister is located, the carrying means having open access means to receive the blister or blister pack.

The dispenser preferably has means to facilitate transmission of compressive pressure on the blister from two opposing fingers.

An opposing surface, for example, may be a finger, a user's arm, a second inside surface of the dispenser, or a surface that creates a channel with the first inside surface.

The dispenser may be flexible or rigid.

Preferably the dispenser comprises a piercing opening means.

The dispenser preferably has fluid directing means that comprises a seal that partially surrounds the opening means and functions under compression the fluid also being directed by dispenser material overlying any opening that it creates.

When viscous materials, such as creams, are being expelled, the opening created by the opening means may be larger and there may be little or no directing means required such as to reduce remaining fluid residue on the dispenser.

Preferably the dispenser enables fluid to be expelled in a desired direction, preferably at right angles to the initial direction of exiting fluid flow.

Preferably the dispenser enables simultaneous compression and opening of the reservoir.

Optionally the carrying means for the opening means is supported by the blister pack during use.

Preferably the dispenser can act on a single blister and preferably is moveable across the surface of a plurality of preferably joined blister reservoirs.

Preferably the dispenser can traverse a blister or blisters.

In the context of this patent application ‘co-operatively attachable’ is used to mean any of; supports or is supported by, is formed on or attached to, or attachable to or fitted to.

There may be one or more dispensing means, dispensing means may be co-operatively attachable to the reservoir blister pack.

Preferably the dispensing means comprises opposed flexible members.

The dispensing means may co-operate with an extension of the blister pack material.

The dispensing means may co-operate or be attached to a blister pack structure joining means.

The dispensing means may be at least partly co-operatively attached or attachable to a blister pack flexible cover, card or forming means.

In use the blister pack may be moved through a dispenser fixed to another structure. Preferably the dispensing means and the blister pack structure are transversely moveable with respect to each other.

Preferably the dispensing means is transversely moveable with respect to the blister pack structure surface.

Optionally the dispensing means comprises two press members that are moveable towards and away from each other.

Preferably the dispensing means has at least a transverse component in relation to its movement with respect to the blister surface.

Optionally the dispensing means comprises opposing members that can be approximated to produce reciprocating pressure.

The dispensing means may be fixed to the blister surface by a flexible cover.

In this patent application, ‘dispensing means’ or ‘opening means’ can mean either one or both of a blister opening means and or a blister pressurising means, either or both of these means preferably being able to traverse or being transversely moveable in respect of the blister pack to selectively engage a particular blister or a part of a blister, by means of an associated ‘carrying means’ or otherwise.

Blister pack is the plural of blister and features pertaining or concerning them are generally interchangeable.

The dispensing means may be fully or partly supported by the blister pack and or a flexible cover that covers all or part of the blister pack structure.

The dispensing means may comprise a seam bursting means or other means.

The dispensing means may moveably co-operate with a forming or stiffening means and be part supported by the forming or stiffening means and part supported directly by the blister pack during use.

The dispensing means may freely surround or moveably co-operate with a forming means.

Preferably the dispensing means, in the form of an opening means and or a pressurising means, is supported by the filled blister and moves in the direction that the blister surface moves as the user applies pressure to the blister wall or walls to compress them together to dispense blister contents, preferably using finger pressure either directly or indirectly over an intervening structure such as a cover or a dispenser.

Preferably where there is a flexible sheet cover, that cover obtains a degree of support from the blister pack and may transmit that support to an overlying dispenser.

Preferably the blister surface or a blister seam is burst in a limited manner such that complete overall tearing of the material surface is avoided when the user applies pressure thereby maintaining a reasonably intact product suitable for the user to continue to use and carry.

The dispensing means may be co-operatively attachable or fixed to the blister pack assembly by a blister pack covering means.

Planar means, for example a compressible plastic or metal means, for example formed as a clip, and external to the blister, may be compressible on each side of the blister in order to fully collapse the blister and ensure complete emptying. The compressible means may preferably have the function of opening the blister by carrying an opening means, such as a piercing means, and facilitate expression of the blister contents by transmission of pressure from the user's fingers to preferably occlude or close up the blister volume.

A dispensing means may be a sliding means.

A dispenser may have a blister pack end attached to its outer wall and the other end of the blister pack fed through it as each blister is emptied. The blister pack having no forming means and remaining entirely flexible and flexibly attached.

A dispensing means may fully or partly surround a blister pack, flexible cover, strip or card.

Preferably an opening piercing means has a guarding means to protect the user's skin.

Preferably a dispensing means is a preferably closed flexible band or loop means that preferably comprises a piercing means on its inside surface.

A dispensing means may be attached by a connector, for example a cord, to the user's pocket and be re-useable and re-attachable to unused blister pack structures.

Preferably the dispensing means facilitates a dosing means.

Alternatively, but not exclusively, the dispensing means comprises two flat rigid plates held by elastic means such that the planar surfaces tend to approximate to each other.

The dispenser may be moveable or sliding, the dispenser may be re-usable or disposable. The blisters may be formed into a preferably closed flexible loop that enables the user's fingers to operate on both sides of an individual blister.

Preferably the user's fingers have access to the space directly above the surface of both blister sides, optionally with a cover and or dispenser in between the blister surface and the user's fingers, preferably enabling a squeezing action between two fingers.

Preferably the dispensing means is able to remain in contact with the blister pack while changing position on the pack surface.

According to a fourth aspect of the present invention, there is provided an assembly comprising an apparatus in accordance with the fourth aspect and a reservoir pack assembly that is preferably characterised as having means that enable the walls of the blisters of the blister pack structure to be compressed together by pressure from a user's fingers thereby reducing the internal volume of any blister thus expelling the blister contents.

The blisters of reservoir pack are preferably compressible.

The blisters of the reservoir assembly may preferably be characterised as being sachet blisters or stick pack blisters.

The blisters of the reservoir assembly may be formed or are formable into a closed loop or band.

Preferably the blister pack structure is unenclosed.

As this is a single product with multiple blisters the term ‘during use’ means that the dispensing means is able to remain in contact with the product while the product as a whole is being used.

In the context of this patent ‘forming means’ and ‘shaping means’ may be interchangeable with ‘stiffening means’ and all may be regarded as a part covering means. The reservoir assembly may comprise a flexible covering means.

The covering means may be attached or attachable, fixed or removable with respect to the blister pack structure.

The reservoir assembly may comprise a covering means or a forming or shaping means for example a flexible sheet cover or a card, wire or other material backing.

The flexible covering means may be characterised as any flexible covering means covering the blister pack assembly in whole or in part and the covering means is preferably fabricated, for example, in the nature of a preferably flexible bag, sheet, or tape rather than a chamber or rigid container.

A forming means, in this patent application, is preferably characterised as not being a rigid container or chamber and preferably it leaves the blister pack structure unenclosed and preferably the forming means and the blister pack structure have a degree of flexibility.

The advance in the art that this represents is that with no cover or with a flexible cover, agent can escape from a blister unhindered and more importantly pressure can be brought to bear over a whole blister surface to expel all or most of the contents.

The forming means may be flexibly metamorphic for example a bendable or re-bendable material, attached or attachable to the blister pack structure, such as a wire and is preferably bendable to any suitable configuration.

The forming means may comprise a plurality of rigid or flexible parts that can move in relation to each other by being jointed or flexibly separated.

Preferably the blister pack reservoir comprises a plurality of sachet packs that has forming or stiffening means attached or attachable such that the user can form the blister pack structure into any suitable shape and ergonomically handle the reservoir as a single product and operate it in a multi dispensing mode.

The blister pack assembly may be formed or is formable into a closed loop of blisters.

Preferably the closed loop of blisters that forms the blister pack structure is flexible.

The opening means may have an elastically flexible quality in a vertical relationship to the blister surface.

Fluid contents contained within the blister are preferably released through an opening in the blister that is directly created by the dispensing means.

The dispensing means preferably comprises fluid directing means.

The opening means may be partially surrounded by a gasket or temporary seal means preferably formed from the surrounding material in order to direct fluid in a particular direction.

Optionally the blister pack structure may be removable from the covering means.

Optionally there may be perforations between blisters to enable individual removal after use.

Optionally and preferably blisters can be opened and used without requiring removal from the joined up line formed by production manufacture.

Optionally the covering means may be fixed to the blister pack structure.

Optionally the covering means freely surrounds the blister pack.

The shaping or firming means may be non elastic or elastic.

Preferably there is a single row or line of blisters in the blister pack structure.

Optionally a structure comprising one or more parts, for example adhesive tape and or wire, may be positioned longitudinally at or adjacent to a long edge of the blister pack the aforesaid structure providing stiffening forming, shaping means and also preferably protective covering means, to protect defined areas of blister surface from being pierced, possibly from under a slidably moveable dispenser and also such a structure may provide a means, such as windows in the structure, through which a cutter may engage the blister surface, to provide the user with a dispenser locating means against each blister.

Optionally the blisters may have means to rotate, relative to each other.

The opening means may be any opening means including peel opening, seam bursting or piercing.

Optionally the opening means is a piercing means that preferably can operate at a position at, near or adjacent to the edge of the blister pack to allow unimpeded exit of agent.

Alternatively the opening means may be a seam bursting means, preferably characterised as a means on each side of the blister, that fully distributes a squeezing pressure over the blister surface area and throughout the blister, for example a planar material on each side of the blister or at its simplest the seam bursting means may be the blister wall alone.

The use of a plurality of sachet packs, preferably constructed from metallised materials, as a single product is especially cost effective as a small bottle replacement as opposed to thermoformed or other formed blisters.

Optionally the blister pack may consist of two or more, preferably four, hinged sections. The hinges may be a combination of snap hinges, as in bottle caps, freely moving or restricted moving hinges. The sections may be comprised of a number of blister packs with stiffening or forming means or the sections may be manufactured separately from the blister packs and the blister packs attached to preferably a complete preferably trapezoidal shape formed from the sections, either as one piece or joined up from a formed length of material. Such a separate manufactured piece may be re-useable and have attachment means, for example ‘Velcro’ for a blister pack strip that has no other shaping means. Such a trapezoidal shape preferably snaps open and shut and has the dispenser easily attached by the user, if connected up by the user, or assembled at manufacture.

A blister dispensing means may be slideable across a blister pack surface whether it is also rotational or deformable.

A cover such as a card or strip of material or a cover of flexible sheet material either planar sheet or a formed cover, with sheet like rather than plastic moulded or metal formed characteristics, preferably non thermoformable and therefore relatively inexpensive, may partially or wholly cover the blister pack structure.

Optionally a blister pack cover may preferably be adhesively fixed to the blister packs and is part of the assembly and in use such a cover may have a pierced opening created through it preferably where it is bonded to the blister substructure.

A forming means may be an elastically flexible coil for attachment around a user's arm.

Preferably a blister pack cover may co-operate with and hold a blister dispensing means on to the blister pack or it may act to provide an overall hygienic smooth surface or it may provide a shielding means against accidental penetration of a blister surface by a piercing dispensing means or it may provide a forming means or a product diffusion barrier, thus allowing a cheaper preferably formable material to be in direct contact with the contained product.

A blister pack forming means, such as a card, may form a blister cutting guard for a rotating or moveable piercing means that can be moved into a piercing mode.

Dispensing locating indicator means that facilitates the location of the dispensing means at each blister, may preferably be sited on the blister pack structure or forming means or cover.

Where there are seals in between blisters these preferably do not require to be perforated for tearing, the product can be made to a specified length, and the seals can therefore be narrower than usual.

The piercing opening means may be moveably rotational around or across the blister or may be sliding with respect to the blister pack structure or may be attached to a flexibly moveable material or flexible cover.

A slidably moveable carrier for the piercing opening means may be made of plastic or metal and may be reusable being easily removable from the blister pack assembly by the user for example by a catch opening means.

Optionally the carrier for a dispensing means may be a strip of formed material with a flexible quality that preferably comprises and allows movement of preferably a plurality of dispenser means by deformation. Such a carrier may also lend a forming means to the blister pack assembly and it may be adhesively or otherwise attached to the blister pack.

The product may comprise stick pack blisters that are positioned side by side on a backing card with the end seals of the packs forming along the card edge.

Alternatively a compartmentalised conventional stick pack with a central fin seal and folded material sides may form the blister assembly.

A side by side stick pack arrangement would give maximum blister doses per unit length of card.

The product may have connecting means of a flexible or elastic or other attachment means for attachment or hanging in a shower cubicle.

In one simple and commercial form this product is a connected assembly of reservoirs, that contain a liquid fluid, in the form of a linear row of flexible blisters, preferably sachet blisters, possibly seam burst opening, with or without a removable or a fixed covering or forming means and the blisters are preferably formable into a loop, or coil or other configuration and the pack may have flexibly metamorphic forming means, the dispensing means may be supported by the blister pack. The dispenser may rest on a forming means or blister structure connecting means until the blisters are in use.

In this application ‘blister’ may mean any blister. The blisters may remain joined together as produced, or separated and re-formed into a pack or used in a cartridge fashion in a preferably compartmentalised flexible holder. This pack may be especially useful in an absence of gravity or outside pressure.

The present invention will now be described by way of example only and with reference to the accompanying figures in which:

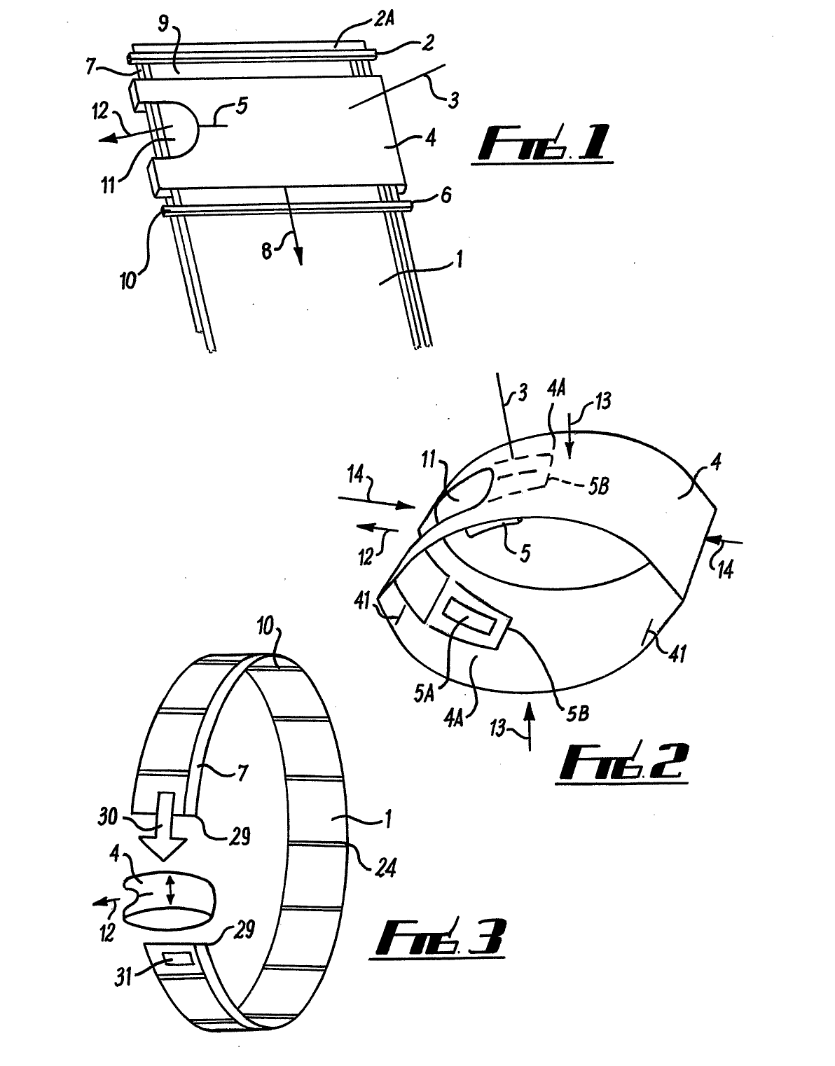

FIG. 1 illustrates in schematic form a sachet blister pack with a sliding loop band dispenser in accordance with an aspect of the present invention;

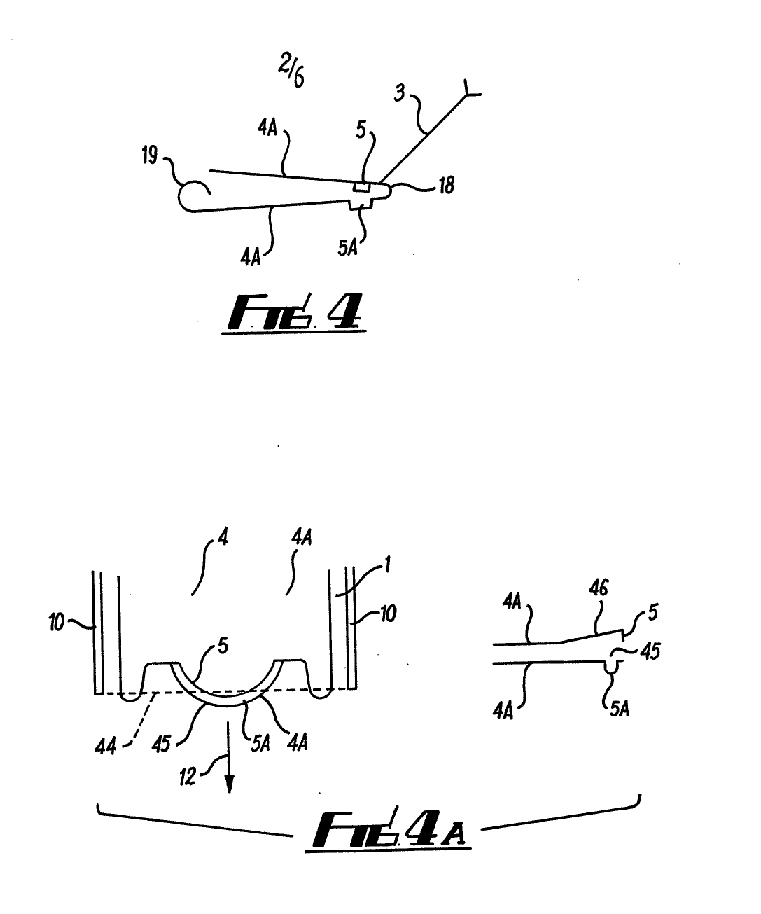

FIG. 2 illustrates in schematic form a sliding loop band dispenser in accordance with an aspect of the present invention;

FIG. 3 illustrates in schematic form a blister pack structure formable as a closed loop in accordance with an aspect of the present invention;

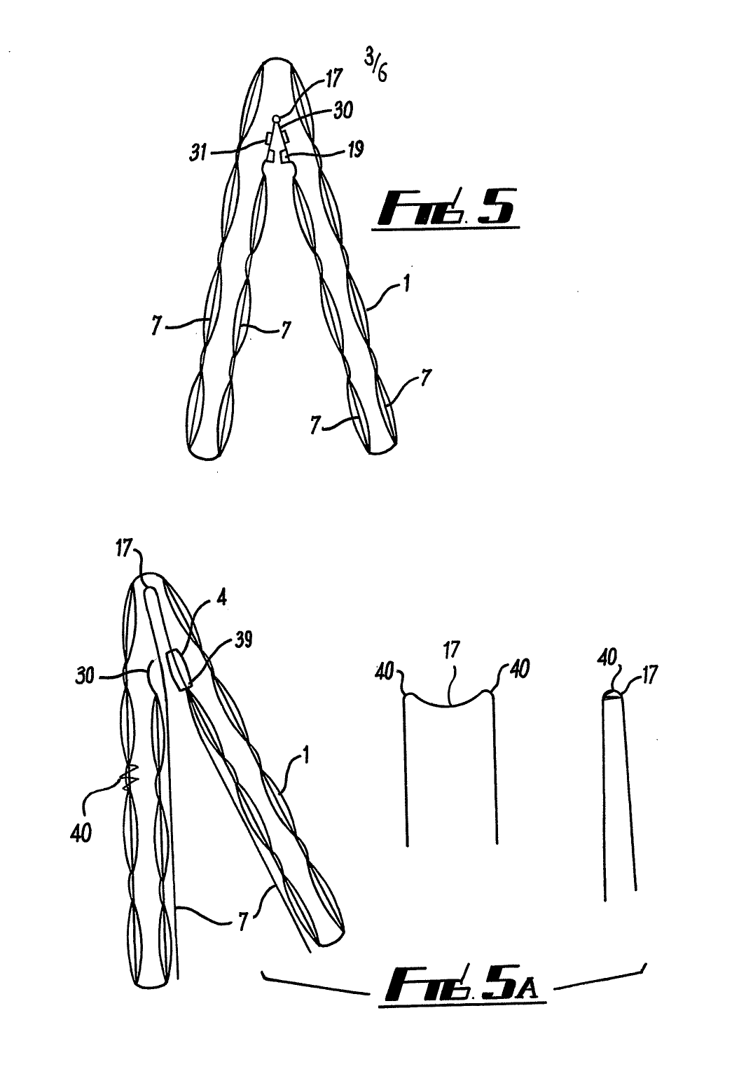

FIG. 4 illustrates in schematic form a sliding dispensing apparatus in accordance with an aspect of the present invention;

FIG. 4A illustrates in schematic form a dispensing apparatus for use with viscous pastes;

FIGS. 5 and 5A illustrate in schematic form an alternative embodiment of a blister pack structure, having hinged portions to shape the structure;

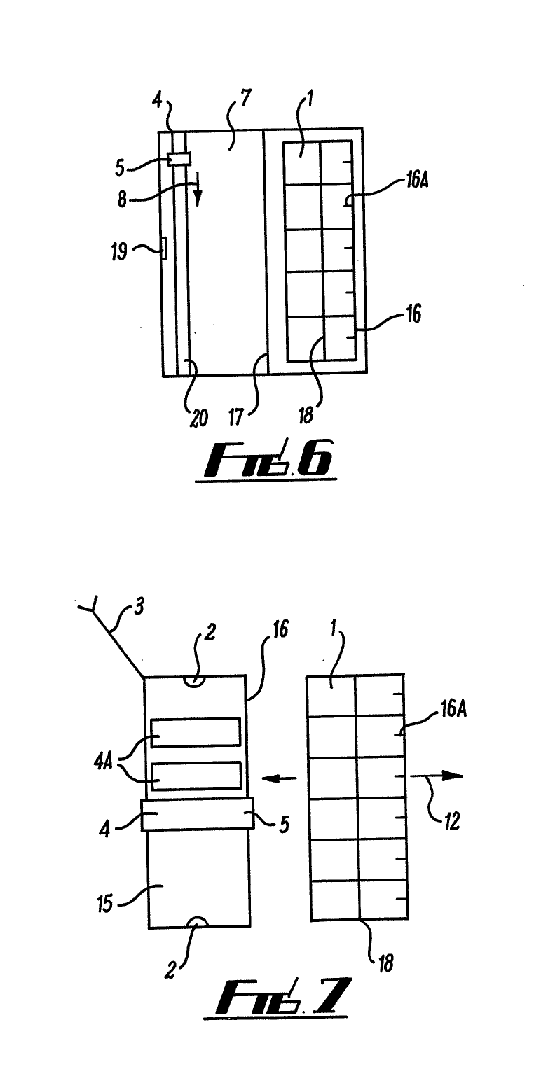

FIG. 6 illustrates in schematic form a further alternative embodiment of the present invention that comprises a folding structure;

FIG. 7 illustrates in schematic form a yet further alternative embodiment of the present invention having a flexible sheet covering;

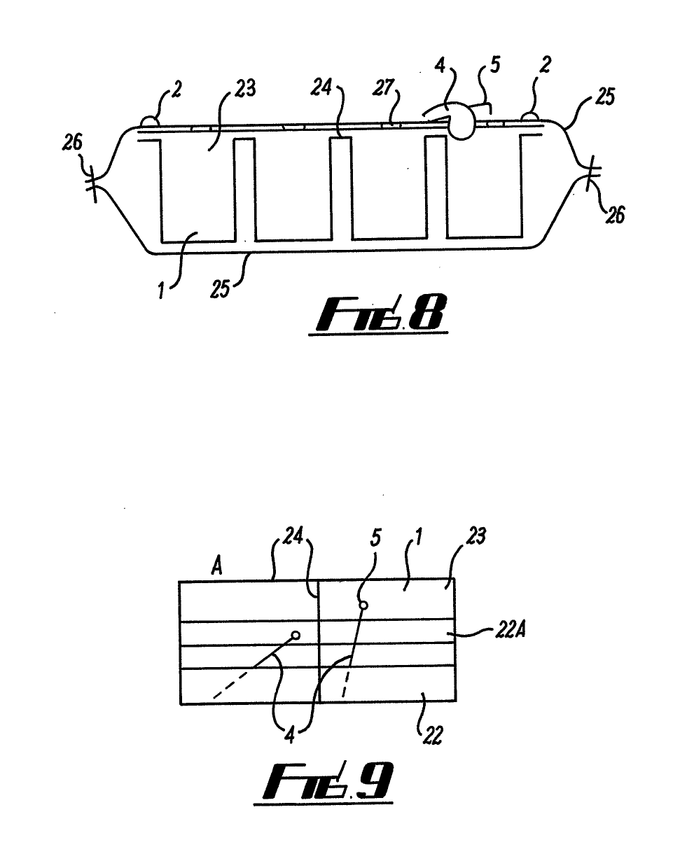

FIG. 8 illustrates in schematic form another alternative embodiment of the present invention which comprises a moveable arm;

FIG. 9 illustrates in schematic form a top down view of the embodiment of FIG. 8;

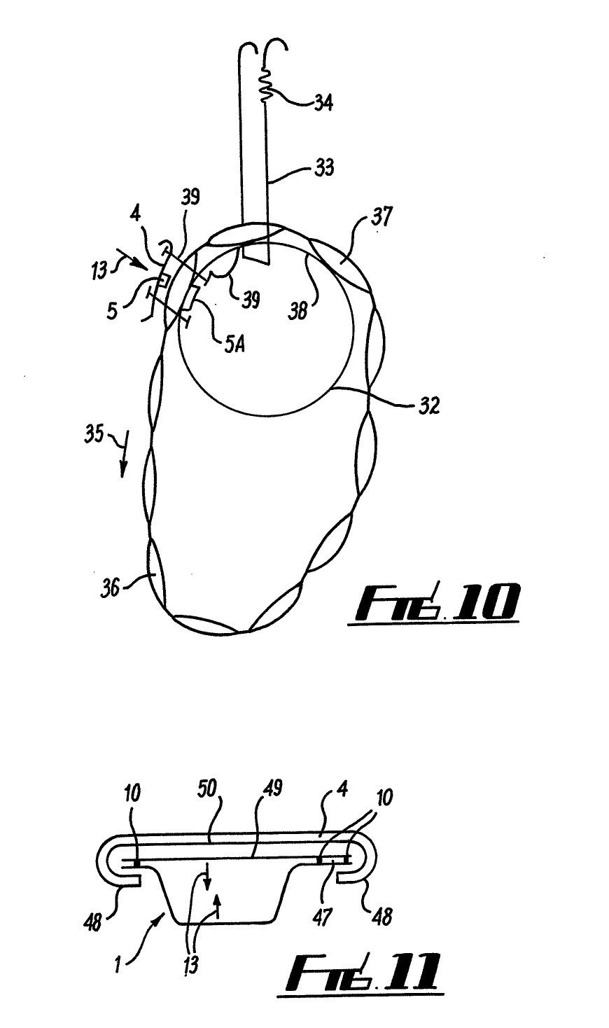

FIG. 10 illustrates in schematic form a hanging product in accordance with an aspect of the present invention; and

FIG. 11 illustrates in schematic form a dispensing slide in accordance with an aspect of the present invention.

In FIG. 1 a blister pack structure 1 comprises a plurality of blisters 1 separated by seals 10, and dispensing means 4 with blister piercing opening means 5 on the underside of dispensing means 4. Dispensing means 4 is directly attached to the blister pack 1 and preferably supported by it. Blister pack 1 preferably comprises sachet blisters. There may be an attachment means 3, for attachment to the user's clothing, connected to the sliding dispensing means 4. Sliding dispensing means 4 may rest over an empty blister and can be moved in direction 8, over the blister pack surface, to a full blister, just before the contents are to be dispensed in direction 12.

Fluid flow is preferably facilitated by cut away open section 11. Initial fluid flow is contra the direction of compressing pressure indicated by arrow 13 in FIG. 2. The dispenser preferably re-directs the fluid flow by overlying the opening created by piercing opening means 5.

Sliding stop means 2 prevents accidental removal of the dispenser 4 from the pack 1. Sliding stop means 2 preferably is a bar of material that overlaps sliding means 4 in width, and is preferably attached to flexible unfilled material 9, and means 2 is fitted to dispensing means 4 by being pushed through the dispensing means 4, when it is formed as a closed loop band, by being flexibly moveable with respect to the band 4. Sliding locating means 6 may be a preferably flexible longitudinal irregular means attached to the blister pack edge and intermittently interfering with the sliding travel of dispensing means 4.

Forming or shaping means 7 may give shape or firmness to the sachet pack 1, to enable ergonomic handling.

Piercing cutting means 5 is located under band 4, such that when the user presses on the dispenser the blister wall ruptures under the band 4 and fluid flows out through opening 11. The piercing opening means 5 and opening 11 are preferably positioned at or adjacent to the sachet side 7 that may be a flat sachet or folded sachet edge.

The user may disengage the piercing means 5 from the blister 1 surface by squeezing the edges of the blister pack 1 in directions 14 (see FIG. 2).

When the dispensing means 4 is a closed loop, the piercing opening means 5 is guarded from a user's finger (not shown) especially when the dispensing means 4 is not attached to a blister pack 1.

Alternatively FIG. 1 may simply comprise seam bursting sachets (not shown) that burst open on application of pressure and preferably have forming means 6 or 7 with no feature 5.

The forming means may be of varying flexibility and may be a backing card, cover or a structural shape formed in the containment material from which the blisters 1 are made.

A loop or band of blisters may be formed; all facilitate ergonomic handling by the user. If a means 4 is present it may simply be a pressuring means. The blister pack 1 may have no forming means 7 and remain foldable by the user.

In FIG. 2 an enlarged top perspective view of a preferably closed band dispenser 4 with preferably flexible walls (preferably elastically flexible walls) is shown. To open up the dispenser 4 for insertion of a blister pack (not shown) or to loosen it to move from one blister to another or to negotiate a bend in the blister pack, pressure is applied in directions 14. On pressing on dispenser walls 4A in direction 13 cutter 5 is moved to engage a blister wall (not shown) and contents (not shown) are expressed in direction 12 through open channel 11. The dispenser wall 4A has a recess 5A into which cutter 5 may enter thus allowing the dispenser walls 4A to fully come together. Partial seal or gasket means 5B is around opening cutter means 5 and directs fluid in the required direction, generally at right angles to initial exit from the blister opening.

Dispenser 4 may have cut relief means 41 that enables the dispenser to negotiate and twist around bends in the pack.

The blisters upon which the dispensing means can operate can be unlike the blisters of the prior art, for example sachet blisters with no other opening means in their structure.

A sliding guard 42, for the cutter, may be moved in directions 43 when initially attached to a pack.

In FIG. 3 blister pack 1 preferably has a single row of blisters 1, preferably sachet blisters, with seals 10. Preferably forming means 7 is present and is preferably flexible and may be adhesively attached to the blisters or be an integral part of the blister material or forming means 7 may be a separate means preferably enabling the blister pack 1 to take up any shape that allows access of the user's fingers to both sides of any individual blister or allows the user's fingers to apply pressure on each side of a blister and preferably enables any suitable shape e.g. a loop, or flat product with one or more bends, with or without the free ends being joined, to be formed as a single product preferably capable of standing for display.

Where bends are indicated the blister surfaces may have protective covering means (not shown) to protect against accidental damage by the piercing means as the dispenser negotiates the bend (not shown).

Blister pack assembly 1 and or forming means 7 may comprise connecting means for the loop ends for example ‘Velcro’ or co-operating slots, in order to be co-operatively attached together. The connecting means may be a separate part (not shown) and may become re-useable and able to accept blister refills the dispenser 4 may be carried by the connecting means 7.

The forming or shaping means is preferably inelastically flexible and may be continuous along the length of the pack or have moveable joints or be in separate section hinged by the blister material.

Loops of blister with or without dispensers attached may be factory preformed. Forming means 7 or connecting means 30 may be any shape and may be hinged. The hinge (not shown) may be restricted in movement preferably being able to move in only 180 degrees.

In the example shown, forming means 7 has its free ends 29 joined by connecting means 30 that co-operates with means 31 to form a closed loop. The free ends 29 may be easily joined and separated using connecting means 30 which also facilitates insertion of free ends 29 into, through, a dispenser 4. The connecting means 30 for example may comprise shaped card 7 or a separate structure with mechanical or adhesive joining means. After release of fluid the loop of blisters may be folded and placed in a pocket using only one hand to close up hinged forming sections. The blister pack or the joining means may have pack closure means 33 for example a ‘Velcro’ dot. Sliding dispensing means 4 can traverse around the loop.

A stop means 2 may not be required as the sliding means 4 can be removed from off an opened end 29 after use and attached to another unused blister strip 1.

In FIG. 4 a sliding dispenser 4 is shown with two rigid plates 4A that can be held closed by catch means 19. The plates 4A flex around a jointed means 18 and on closure cutter 5 is protected from the user's fingers (not shown) by recess 5A. This dispenser preferably requires pressure to be closed and preferably is held open by elastic means. Design of blister opening means will depend on the consistency and fluid dynamics of the blister contents.

FIG. 4A shows a sliding dispenser with an opening means 5 for use with sticky, viscous pastes, for instance toothpaste.

The cutter or piercing means 5 is preferably “U” or “V” shaped, and preferably cuts a flap (not shown) adjacent to or over the folded edge 44 of the preferably stick pack blister 1 having seals 10. The flap remains attached and preferably the cutter 5 does not penetrate the opposing blister wall 4A as it is supported by the finger guard wall 4A, thus also preventing residue from collecting on the inside of the dispenser 4, and an uncovered hole 45 in the blister is thus formed.

The cutter 5 may have retraction or disengagement means, preferably elastic in nature, for example the cutter may be sited on an elevated elastically depressible means 46 that is preferably an extension of dispenser wall 4A. On compression of the dispenser 4 a bead of paste is expelled in direction 12, the raised means 46 allowing the bead to form. On depressing the means 46 the bead is finally cut off. The same continuous action may compress a preferably rigid blister compression means 4A, the mechanism preferably returning to an open position by elastic means.

In FIGS. 5 and 5A a closed flexible loop of sachets 1, with four separate forming means 7 is shown, a looped shape as previously shown, can become flattened into a joined up double or quadruple row of blisters, suitable for pocket insertion and provides acceptable handling ergonomics compared to a bottle (not shown).

This form of product may be provided flat, ready to be connected and the dispenser (not shown) may be re-useable or it may be fully factory assembled, for complete disposal after use.

A base or feet (not shown) enabling the product to be displayed in an upright position may be formed as part of the forming or shaping means 7, or be attachable to said means 7. Being able to stand upright, for example, presents a tidy and attractive form factor.

Hinge 17 may simply be a joining of the blisters or it may be a restricted movement hinge, for example a snap hinge, that enables the pack to stand up for display. Alternatively a blister pack assembly 1 may have no cover or forming means 7 and remain entirely flexible and foldable, making a virtue of this feature thus enabling it to be bundled into a pocket without fear of blisters accidentally leaking. This simple product only requires the user to control the holding of the product with the palm of the hand during use.

In FIG. 6 a card or forming means 7 is hinged at 17. Blister pack 1 has a folded edge 16 and preferably a central fin seal 18 as in a stick pack and is preferably attached or attachable to means 7 which can be closed using catch means 19. Dispensing means 4 with opening means 5 can slide in direction 8 on sliding means 20. when the forming means 7 is folded over at hinge 17 the opening means 5 engages a blister and pierces the blister at position 5A.

In FIG. 7 a flexible sheet covering means 15 has attachment means 3 to be attached to a pocket or belt (not shown). The flexible covering means 15 has sliding dispensing means 4 encompassing it and stop means 2. Blister pack 1 is placed inside cover 15 through open side 16. Panels 4A correlate to the blisters of a blister pack 1. Blister edges 16A has a frangible seam or a folded edge or a sealed edge for piercing by means 5 in that position.

Dispensing means 4 can ride over rigid panels 4A that move independently. On pressuring the panels 4A or the dispenser 4 liquid fluid agent is expelled from the blisters in direction 12 at right angles.

In FIG. 8 a row of formed blisters 1 with sealed tops 23 and seals 24 between the blisters is further covered by cover 25 that is preferably attached to the blisters at points 27. The cover has end stops 2 and preferably hermetically seals the blister assembly by seals 26. The dispensing means 4 can slide along the blister assembly and the user can pierce into individual blisters without compromising the rest of the pack by pressuring piercing opening means 5 at an adhesive laminated section. This arrangement may be used with sachets or formed blisters.

In FIG. 9 dispensing means 4 in the form of a flexible arm of preferably plastic material has piercing opening means 5 attached. The dispensing means is fixed to the blister surface 1 by covering means 22 and at rest, as shown on blister A, lies on top of protective covering means 22A. On blister B the dispensing means has moved under pressure from the user, to a frangible part 23 of the surface of blister B not covered by cover 22. A frangible surface may be achieved by laser ablation. This blister type preferably has a thermoformed base and frangible lid and is suitable for powder dispensing. Blister seals 24 are shown.

In FIG. 10 a side view, fluid exit in the foreground (out of the page) of a hanging product, possibly a shower gel dispenser, is shown.

The blister pack loop 1 may freely pass over a supporting preferably curved surface means 32, for example a tube section or roller, that may be attached, for example, to a wall (not shown). The supporting means 32 has curved guiding means 38 that guides blisters under the dispensing means 4 that preferably has rounded edges 38.

Preferably the supporting means 32 has hanging attachment means 33 with elastic means 34 that allows the blister pack and means 32 to be tilted by the user such that the fluid exit (not shown) can be directed downwards. The means 32 preferably does not roll while the user pulls the blister strip in direction 35 by pulling on empty blisters 36 to bring full blisters 37 into position under dispensing means 4. Dispensing means 4 has piercing means 5 and gasket or seal means (not shown) that co-operates with recess guard 5A on the curved surface means 32. The roller or curved blister lead in means 38 may have a blocking means 39 such that a user's finger can access under the blister from one side only.

Preferably dispensing means 4 is rigid and is shaped to co-operate with the surface under the blister 1. The dispensing means 4 has hinged attachment means 39 preferably loosely attached to the roller supporting means 32.

In use the user easily accesses both sides of the blister to compress the dispensing means 4 in direction 13. Where waste recovery is a consideration it is ergonomic for the user and more practical and economic for recycling to collect and dispose of joined blisters than single blisters.

FIG. 11 shows a basic embodiment of the present invention wherein a slide 4 is located over a blister 1 and partially encloses it (by means of extended portions indicated by reference numeral 48). The blister 1 is sealed with seals indicated by reference numerals 10. A coiling or shaping means (not shown) may be inserted into a shaping means locator 47 adapted to receive it. The coiling or shaping means will thus shape an array of blisters 1 into a preferred shape.

Exerting pressure by compression of the blister in a direction indicated by arrows 13 will cause the fluid within to become pressurised as the blister top 49 is urged into contact with the inner surface 50 of the slide 4. With increased pressure, the leftmost seal 10 will burst, thus allowing expression of the contained fluid.

This application allows a completely new type of product, a multiple fluid filled blister pack, preferably a sachet pack, as a replacement for bottles, especially small volume bottles and less ergonomic single loose blister packs, that is simple and is a beneficial advance on these bottles and packs.

The prior art herein cited does not teach the inventive features of the present invention, nor enjoy the benefits thereof. The present invention is new and leads to initially unexpected advantages such as reduction in bulk during use and a production cost of less than one third of an equivalent volume small dosing carry bottle.

Furthermore, where waste recovery is a consideration it is ergonomic for the user and more practical and economic for recycling to collect and dispose of a number of joined blisters than separate individual blisters.

The problem of siting a bottle within a shower enclosure and having a controlled release of agent can also be addressed by using the current invention.

The problems in achieving an extremely low cost fully ergonomic preferably multi dose fluid filled blister pack alternative to a bottle, for example a small 50 ml.-100 ml. carry bottle, and the solutions to the problems of use and disposal are solved by the present invention. It provides an improved, and cheaper, product which is more environmentally friendly than the prior art. The predicted increase in uptake therefore has associated benefits for all.

Further modifications and improvements may be added without departing from the scope of the invention as defined by the appended claims.

1-48. (canceled)

49. A dispenser for dispensing fluid from a blister containing fluid, the dispenser comprising:
a first member and a piercing means located on the first member;
the first member moveable so as to compress at least some of the fluid in cooperation with an opposing member and cause the piercing means to provide an opening in the blister, such that at least some of the fluid is ejected from the blister through the opening.

50. A dispenser as claimed in claim 49, adapted so as to allow relative movement of the first member and the piercing means in a direction substantially parallel to the surface of the blister.

51. A dispenser as claimed in claim 49 wherein, the dispenser is at least partially supported by the blister.

52. A dispenser as claimed in claim 49 wherein, the dispenser further comprises a second member which opposes the first member, and is adapted to cooperate with the first member.

53. A dispenser as claimed in claim 49 wherein, the dispenser comprises a channel, formed by the first and a second opposing member, which receives and at least partially encloses the blister.

54. A dispenser as claimed in claim 49 wherein, the first and a second opposing member are shaped so as to substantially engage one another when urged toward one another.

55. A dispenser as claimed in claim 49 wherein, the dispenser provides a preferred fluid flow path for ejection of the fluid, the path being at least partly defined by the opening in the blister.

56. A dispenser as claimed in claim 49 wherein, the dispenser further comprises an aperture positioned proximal to the piercing means and configured so as to define a preferred fluid flow path in cooperation with the opening in the blister.

57. A dispenser as claimed in claim 49 wherein, the dispenser is adapted so as to provide a preferred fluid flow path when the first member is moved toward the blister and deconstruct the preferred fluid flow path when the first member moves away from the blister.

58. A dispenser as claimed in claim 57 wherein, the dispenser further comprises a gasket portion adapted to provide a partial seal proximal to the opening and to cooperate with the preferred fluid flow path such that the fluid is directed from the opening to an aperture.

59. A dispenser as claimed in claim 49 wherein, the piercing means is shaped so as to create an opening capable of cooperating with a preferred fluid flow path.

60. A dispenser as claimed in claim 49 wherein, the dispenser further comprising a relief structure located on an inner surface opposing the piercing means and adapted to cooperate with the piercing means.

61. A dispenser as claimed in claim 60 wherein, the relief structure comprises a hardened portion adapted to receive the piercing means.

62. A dispenser as claimed in claim 49 wherein, the dispenser comprises a second opposing member formed by a substantially cylindrical body adapted to receive a finger.

63. A dispenser as claimed in claim 49 wherein, the first member is adapted to conform to the opposing member so as to allow substantially all of the fluid in the blister to be ejected.

64. A dispenser assembly comprising:
an array comprising a plurality of fluid filled blisters; and
a dispenser comprising a first member and a piercing means located on the first member; the first member moveable so as to compress at least some of the fluid in a first of the plurality of blisters in cooperation with an opposing member and cause the piercing means to provide an opening in the first blister, such that at least some of the fluid is ejected from the first blister through the opening; and
the dispenser adapted to relatively move the first member and the piercing means from the first to a second of the plurality of blisters.

65. A dispenser assembly as claimed in claim 64 wherein, the dispenser comprises a channel, formed by the first and a second opposing member, which receives and at least partially encloses the array of blisters.

66. A dispenser assembly as claimed in claim 64 wherein, the array of blisters comprises a deformable shaping means adapted to form the array into a predetermined shape.

67. A dispenser assembly as claimed in claim 64 wherein, the array of blisters is shaped into a loop.

68. A dispenser assembly as claimed in claim 64 wherein, the plurality of blisters comprise sachets or stick packs.

69. A dispenser for dispensing fluid from one of a plurality of connected fluid filled blister packs, wherein:
the dispenser is relatively moveable from a position at or near a first of the plurality of blister packs to a position at or near a second blister pack on either side of the first blister pack; and
the dispenser comprising an opening means moveable to act against one of the plurality of blister packs in a direction transverse to the direction of movement of the dispenser and enable release of the fluid in one of the plurality of blister packs in a direction at least partly vectored against the direction in which the opening means acts.

70. A dispenser as claimed in claim 69 wherein, the opening means comprises a piercing means adapted to create an opening in one of the plurality of blister packs.

71. A dispenser as claimed in claim 69 wherein, the dispenser is supported by one or more of the plurality of blister packs.

72. A dispenser as claimed in claim 69 wherein, the dispenser further comprises the plurality of fluid filled blister packs and a shaping means arranged on the blister packs to enable a user to shape the connected blister packs.
